(19) United States
(12) Patent Application Publication
(10) Pub. No.: US 2021/0010520 A1
(43) Pub. Date: Jan. 14, 2021

(54) DUMBBELL-LIKE BIDIRECTIONAL TAPERED BOLT-NUT THREADED CONNECTION STRUCTURE WITH LARGE-CONICITY LEFT SIDE AND SMALL-CONICITY RIGHT SIDE

(71) Applicant: AMICUS VERITATIS MACHINERY CO., LTD., TAIZHOU (CN)

(72) Inventor: Yihua YOU, TAIZHOU (CN)

(21) Appl. No.: 17/036,013

(22) Filed: Sep. 29, 2020

Related U.S. Application Data
(63) Continuation of application No. PCT/CN2019/081388, filed on Apr. 4, 2019.

(30) Foreign Application Priority Data
Apr. 7, 2018 (CN) 201810303107.1

(51) Int. Cl. F16B 35/04

(52) U.S. Cl. CPC F16B 35/041

(57) ABSTRACT

Disclosed is a dumbbell-like bidirectional tapered bolt-nut threaded connection structure with a large-conicity left side and a small-conicity right side, which solves the problems that the existing thread is poor in the self-positioning and self-locking property. The internal thread (6) is a cylindrical body (2) with a bidirectional tapered hole (41) on the inner surface (non-solid space). The external thread (9) is a columnar body (3) with a bidirectional truncated cone (71) on the outer surface (material entity). The whole unit thread is a spiral dumbbell-like (94) bidirectional tapered body with a small middle part and two large ends, the conicity of the left side (95) is greater than the conicity of the right side (96). The performance mainly depends on the taper surfaces and the conicity size of the threads matching with each other.

### CROSS-REFERENCE TO RELATED APPLICATIONS

This application is a continuation of International Patent Application No. PCT/CN2019/081388 with a filing date of Apr. 4, 2019, designating the United States, now pending, and further claims priority to Chinese Patent Application No. 201810303107.1 with a filing date of Apr. 7, 2018. The content of the aforementioned applications, including any intervening amendments thereto, are incorporated herein by reference.

### TECHNICAL FIELD

The present invention belongs to the technical field of general technology devices, and relates to a dumbbell-like bidirectional tapered bolt-nut threaded connection structure with a large-conicity left side and a small-conicity right side, which is a dumbbell-like (the conicity of the left side is greater than the conicity of the right side) asymmetric bidirectional tapered bolt-nut threaded connection structure (hereinafter referred to as “bidirectional tapered threaded bolt and nut”).

### BACKGROUND

The invention of the thread has a profound impact on the progress of human society. Thread is one of the most basic industrial technologies. It is not a specific product, but a key common technology in the industry. Its technical performance must be embodied by a specific product as an application carrier, and it is widely used in various industries. The existing thread technology has a high level of standardization, mature technical theory, and long-term practical application. When used for fastening, it is a fastening thread; when it is used for sealing, it is a sealing thread; when it is used for transmission, it is a transmission thread. According to the national standard thread terminology: “thread” refers to a tooth on the surface of a cylinder or cone that has the same tooth profile and continuously bulges along a spiral line; “tooth” refers to the material entity between adjacent flanks. This is also the threaded definition known by the world.

The modern thread began in 1841 with the British Whitworth thread. According to modern thread technology theory, the basic condition for thread self-locking is as follows: the equivalent friction angle should not be less than the lead angle. This is an understanding of the modern thread technology based on its technical principle, that is, “inclined plane principle”, which has become an important theoretical basis for the modern thread technology. Steven made a theoretical explanation of the inclined plane principle first. He researched and discovered the conditions for the balance of objects on the inclined plane and the parallelogram law of force synthesis. In 1586, he proposed the famous inclined plane law: the gravity along the inclined plane to which an object placed on the inclined plane is subject to is proportional to the sine of the inclination angle. The inclined plane refers to a smooth plane inclined to the horizontal plane. The helix is a deformation of the “inclined plane”. The thread is like an inclined plane wrapped around a cylinder. The smoother the inclined plane, the greater the mechanical benefit (refer to FIG. 7) (Yang Jingshan and Wang Xiuya, “Discussion on the Principle of Screws”, “Research on Gaussian Arithmetic”).

The “inclined surface principle” of modern threads is an inclined surface slider model based on the inclined surface law (refer to FIG. 8). It is believed that under the condition of small static load and temperature change, when the thread lead angle is less than or equal to the equivalent friction angle, the thread pairs have self-locking conditions. The thread lead angle (refer to FIG. 9) is also referred to as the thread angle of lead, which is the angle between the tangent of the spiral line on the pitch diameter cylinder and the plane perpendicular to the thread axis. This angle affects the self-locking and anti-loosening of the thread. The equivalent friction angle is the corresponding friction angle when different friction forms are finally transformed into the most common inclined slider form. Generally, in the inclined plane slider model, when the inclined plane is inclined to a certain angle, the friction force of the slider at this time is exactly equal to the component of gravity along the inclined plane. At this time, the object is just in the equilibrium state of force, and the inclined plane inclination angle at this time is referred to as the equivalent friction angle.

American engineers invented the wedge-shaped thread in the middle of the last century, and its technical principle still follows the “inclined plane principle.” The invention of the wedge-shaped thread was inspired by the “wood wedge”. Specifically, the structure of wedge-shaped thread is that there is a wedge-shaped inclined surface at the tooth root of the internal thread (i.e., a nut thread) of the triangular thread (commonly known as an ordinary thread), which forms an included angle of 25° to 30° with the thread axis. The actual engineering takes the wedge-shaped inclined surface of 30°. For a long time, people have researched and solved thread anti-loosening problems from the technical level and the technical direction of the thread profile angle. The wedge-shaped thread technology is no exception, and it is the specific application of the tapered wedge technology.

However, the existing threads have problems such as low connection strength, weak self-positioning ability, poor self-locking, low load-bearing value, poor stability, poor compatibility, poor reusability, high temperature and low temperature, etc. The typical problem is that bolts or nuts using modern thread technology have common defects of easy loosening. With frequent vibration or shocking of devices, bolts and nuts can loosen or even fall off, and even safety accidents are prone to occur.

### SUMMARY

Any technical theory has theoretical hypothesis background, and thread is no exception. With the advancement of science and technology, the damage to the connection is no longer a simple linear load, or static state, or room temperature environment. There are linear loads, non-linear loads or even the superposition of the linear loads and the non-linear loads, resulting in a more complex situation having damage to load, and the application conditions are complex. Based on this understanding, the object of the present invention is to solve the above problems and provide a bidirectional tapered bolt-nut threaded connection structure with reasonable design, simple structure, and good connection performance and locking property.

In order to achieve the above object, the present invention adopts the following technical solutions: the dumbbell-like (the conicity of the left side is greater than the conicity of the right side) asymmetric bidirectional tapered bolt-nut threaded connection structure is used by a threaded connection pair formed by an internal thread of the asymmetric bidirectional tapered thread and an external thread of the asymmetric bidirectional tapered thread. It is a special thread pair technology that combines the characteristics of the conical pair and the spiral movement. The bidirectional tapered thread is a thread technology combining the technical characteristics of the bidirectional cone and the spiral structure. The bidirectional cone is formed by two single cones. It is formed bidirectionally by two single cones with the same direction of the conicity of the left side and the conicity of the right side, and the conicity of the left tapered body is greater than the conicity of the right tapered body. The bidirectional tapered body is spirally distributed on the outer surface of the columnar body to form an external thread and/or the bidirectional tapered body is spirally distributed on the inner surface of the cylindrical body to form an internal thread. Regardless of the internal thread or the external thread, the whole unit thread is a dumbbell-like special bidirectional tapered geometry with a small middle part and two large ends in which the conicity of the left side is greater than the conicity of the right side.

For the bidirectional tapered threaded bolt and nut, the dumbbell-like asymmetric bidirectional tapered thread definition can be expressed as: “a spiral dumbbell-like special bidirectional tapered geometry with a small middle part and two large ends having asymmetric bidirectional tapered holes (or asymmetric bidirectional truncated cones) and are continuously and/or discontinuously distributed along the spiral line, in which the conicity of the left side and the conicity of the right side are prescribed, the conicity of the left side and the conicity of the right side have opposite directions, and the conicity of the left side is greater than the conicity of the right side.” Due to manufacturing reasons, the head and tail of an asymmetric bidirectional tapered thread may be incomplete bidirectional tapered geometry. Different from the modern thread technology, the thread technology has changed from the original enveloping relationship of the internal thread and the external thread of the modern thread to the enveloping relationship of the internal thread and the external thread of the bidirectional tapered thread.

The bidirectional tapered threaded bolts and nuts comprise a bidirectional truncated cone spirally distributed on the outer surface of the columnar body and a bidirectional tapered hole spirally distributed on the inner surface of the cylindrical body, that is, comprise an external thread and an internal thread that are threaded with each other. The internal thread distributes a spiral bidirectional tapered hole and exists in the form of “non-solid space”, and the external thread distributes a spiral bidirectional truncated cone and exists in the form of a “material entity”. The non-physical space refers to the space environment that can accommodate the material entity. The internal thread is the containing part, and the external thread is the contained part: the internal thread and the external thread are bidirectional tapered geometries that are screwed and sleeved together until one side bears in both directions or the left and right sides bear in both directions simultaneously or until the size is interference fit. Whether the two sides bear in both directions simultaneously depends on the actual working conditions of the application field, that is, the bidirectional tapered hole contains and envelops the bidirectional truncated cone in sections, that is, the internal thread is corresponding to the external thread by envelopment in sections.

The threaded connection pair is a cone pair formed by a spiral outer conical surface and a spiral inner conical surface that cooperate to form a thread pair. The outer conical surface of the outer cone and the inner conical surface of the inner cone of the bidirectional tapered thread are both bidirectional conical surfaces. When the bidirectional conical threads form a threaded connection pair, the joint surface of the inner conical surface and the outer conical surface is used as the supporting surface, that is, the conical surface is used as the supporting surface to realize the connection technical performance. The self-locking property, self-positioning property, reusability and fatigue resistance of the thread pair mainly depend on the conical surface and the conicity size of the cone pair forming the bidirectional tapered bolt-nut threaded connection structure, that is, the conical surface and the conicity size of the internal thread and the external thread. The thread is a non-tooth thread.

Different from the unidirectional force distributed on the inclined plane and the meshing relationship of the internal and external threads between the internal tooth and the external tooth, which is shown by the existing thread inclined plane principle, for the bidirectional tapered threaded bolt and nut, no matter whether the thread (that is, the bidirectional tapered body) is distributed on the left or right side, the single tapered body is bidirectionally formed by two element lines of the cone through the conical axis section, and is in the bidirectional state. The element line is the intersection of the conical surface and the plane passing through the conical axis. The conical principle of the bidirectional tapered bolt-nut threaded connection structure shows the axial force and the anti-axial force, both of which are combined by the bidirectional force. The axial force and the corresponding anti-axial force are opposite. The internal thread and the external thread are in an enveloping relationship, that is, the thread pair is formed by the internal thread envelops the external thread, that is, a section of tapered holes (the inner cone) envelops the corresponding section of cones (the outer cone) until the enveloping size cooperates to realize self-positioning or until the size realizes interference contact to realize self-locking, that is, the tapered hole and the truncated cone radially envelop together so that the inner cone and the outer cone are self-locked or self-positioned to realize the self-locking or self-positioning of the thread pair, rather than the internal thread and the external thread of the traditional thread forming a threaded connection pair, which realizes the threaded connection performance through the mutual abutment between the teeth.

There will be a self-locking force when the internal thread and the external thread meet certain conditions during the enveloping process. The self-locking force is generated by the intensity of pressure generated between the axial force of the inner cone and the anti-axial force of the outer cone, that is, when the inner cone and the outer cone form a cone pair, the inner conical surface of the inner cone envelops the outer conical surface of the outer cone, and the inner conical surface is in close contact with the outer conical surface. The axial force of the inner cone and the anti-axial force of the outer cone are the unique force concept of the bidirectional tapered thread technology of the present invention, that is, the cone pair technology.

The inner cone exists in a form similar to a shaft sleeve. Under the action of external load, the inner cone generates an axial force pointing to or pressing against the conical axis. The axial force combined in both directions by a pair of centripetal forces which are distributed in an mirror image centered on the conical axis and are perpendicular to the two element lines of the cone, that is, the axial force passing through the conical axis section is formed by two centripetal forces which are distributed on both sides of the conical axis in both directions in an mirror image centered on the conical axis, are perpendicular to the two element lines of the cone, and point to or press against the common point of the conical axis. When the cone and the spiral structure are combined into a thread and applied to the thread pair, the axial force passing through the thread axis section is formed by two centripetal forces which are distributed on both sides of the thread axis in both directions in an mirror image and/or an approximate mirror image centered on the thread axis, are perpendicular to the two element lines of the cone, and point to or press against the common point and/or the approximately common point of the thread axis. The axial force is densely distributed on the conical axis and/or the thread axis in an axial and circumferential manner. The axial force corresponds to an axial force angle. The included angle of the two centripetal forces forming the axial force constitutes the axial force angle, and the magnitude of the axial force angle depends on the conicity size of the cone, that is, the size of the taper angle.

The outer cone exists in a form of a shaft and has a strong ability to absorb various external loads. The outer cone generates an anti-axial force opposite each axial force of the inner cone. The anti-axial force combined in both directions by a pair of anti-centripetal forces which are distributed in an mirror image centered on the conical axis and are perpendicular to the two element lines of the cone, that is, the anti-axial force passing through the conical axis section is formed by two anti-centripetal forces which are distributed on both sides of the conical axis in both directions in an mirror image centered on the conical axis, are perpendicular to the two element lines of the cone, and point to or press against the inner conical surface from the common point of the conical axis. When the cone and the spiral structure are combined into a thread and applied to the thread pair, the anti-axial force passing through the thread axis section is formed by two anti-centripetal forces which are distributed on both sides of the thread axis in both directions in an mirror image and/or an approximate mirror image centered on the thread axis, are perpendicular to the two element lines of the cone, and point to or press against the conical surface of the internal thread from the common point and/or the approximately common point of the thread axis. The anti-axial force is densely distributed on the conical axis and/or the thread axis in an axial and circumferential manner. The anti-axial force corresponds to an anti-axial force angle. The included angle of the two anti-centripetal forces forming the anti-axial force constitutes the anti-axial force angle, and the magnitude of the anti-axial force angle depends on the conicity size of the cone, that is, the size of the taper angle.

The axial force and anti-axial force begin to be generated when the inner and outer cones of the cone pair are in effective contact, that is, a pair of corresponding and opposite axial force and anti-axial force always exists during the effective contact process of the inner cone and the outer cone of the cone pair. The axial force and anti-axial force are both bidirectional forces centered on the conical axis and/or the thread axis and distributed in both directions in a mirror image instead of unidirectional forces. The conical axis and the thread axis are the coincidence axis, that is, the same axis and/or approximately the same axis. The anti-axial force and the axial force are oppositely collinear, and when the cone and the spiral structure are combined into threads and form a thread pair, they are oppositely collinear and/or approximately oppositely collinear. The inner cone and the outer cone are enveloped until the interference, and the axial force and anti-axial force generate intensity of pressure at the contact surface of the inner conical surface and the outer conical surface, and are densely distributed axially and evenly at the contact surface of the inner and outer conical surfaces in the circumferential direction. When the enveloping movement of the inner cone and the outer cone continues until the cone pair reaches the intensity of pressure generated by the interference fit, and the inner cone and the outer cone are combined, that is, the intensity of pressure causes the inner cone to envelop the outer cone to form a similar overall structure. After the external force resulted therefrom disappears, the inner cone and the outer cone will not be separated from each other under the action of gravity due to the arbitrary change of the position direction of the similar overall structure. The cone pair will be self-locked, that is, the thread pair will be self-locked. The self-locking property also has a certain limit of resistance to other external loads that may cause the inner cone to be separated from the outer cone in addition to gravity. The cone pair also has the self-positioning property that the inner cone and the outer cone cooperate with each other, but not any axial force angle and/or anti-axial force angle can cause the cone pair to be self-locked and self-positioned.

When the axial force angle and/or the anti-axial force angle are less than 180° and greater than 127°, the cone pair is self-locking. When the axial force angle and/or the anti-axial force angle are infinitely close to 180°, the self-locking property is the best, and its axial bearing capacity is the weakest. When the axial force angle and/or the anti-axial force angle are equal to and/or less than 127° and greater than 0°, the cone pair is in the interval of having weak self-locking and/or no self-locking. When the axial force angle and/or the anti-axial force angle tend to change infinitely close to 0°, the self-locking property of the cone pair will change in a decreasing trend until it has no self-locking ability at all. The axial bearing capacity change in an increasing trend until the axial bearing capacity is the strongest.

When the axial force angle and/or the anti-axial force angle is less than 180° and greater than 127°, the cone pair is in a strong self-positioning state, and it is easy for the inner and outer cones to achieve strong self-positioning. When the axial force angle and/or the anti-axial force angle are infinitely close to 180°, the inner and outer cones of the cone pair have the strongest self-positioning ability. When the axial force angle and/or the anti-axial force angle are equal to and/or less than 127° and greater than 0°, the cone pair is in a weak self-positioning state. When the axial force angle and/or the anti-axial force angle tend to change infinitely close to 0°, the mutual self-positioning ability of the inner and outer cones of the cone pair will change in a decreasing trend until it nearly completely has no self-positioning ability.

Compared with the containing and contained relationship of the irreversibility unilateral bidirectional containment that the unidirectional tapered thread of the single tapered body invented by the applicant before can only bear at a single side of the conical surface, for the bidirectional tapered threaded connection pair, the reversibility bidirectional containment of the bidirectional tapered thread of the bidirectional tapered body at the left and right sides causes the left side of the conical surface to bear and/or the right side of the conical surface to bear and/or the left side conical surface and the right side conical surface to bear respectively and/or the left side conical surface and the right side conical surface to bear in both directions at the same time, which further restricts the disordered degree of freedom between the tapered hole and the truncated cone. The spiral movement allows the bidirectional tapered bolt-nut threaded connection structure to obtain the necessary orderly degree of freedom, effectively combining the technical characteristics of the cone pair and the thread pair to form a new thread technology.

In the use of the bidirectional conical threaded bolt and the nut, the conical surface of the bidirectional truncated cone of the external thread of the bidirectional conical thread is matched with the conical surface of the bidirectional tapered hole of the internal thread of the bidirectional conical thread.

For the bidirectional tapered threaded bolt and nut, the bidirectional tapered body of the taper pair, namely the truncated cone and/or the tapered hole, does not have any conicity or any taper angle which can realize the self-locking and/or self-positioning of the threaded connection pair. The inner and outer cones of the bidirectional tapered body must reach a certain conicity or a certain taper angle. The bidirectional tapered bolt-nut threaded connection structure can have self-locking and self-positioning properties. The conicity comprises the conicity at the left side and the conicity at the right side of the internal and external threads. The taper angle comprises the left taper angle and the right taper angle of the internal and external threads. The internal thread and the external thread of the asymmetrical bidirectional tapered thread forming the dumbbell-like asymmetric bidirectional tapered bolt-nut threaded connection structure has the conicity at the left side greater than the conicity at the right side. The conicity at the left side corresponds to the left taper angle, that is, the first taper angle α1, preferably, the first taper angle α1 is greater than 0° and less than 53°, preferably, the first taper angle α1 takes a value of 2°-40°. In individual special fields, preferably, the first taper angle α1 is greater than or equal to 53° and less than 180°, preferably, the first taper angle α1 takes a value of 53°-90°; the conicity at the right side corresponds to the right taper angle, that is, the second taper angle α2, preferably, the second taper angle α2 is greater than 0° and less than 53°, preferably, the second taper angle α2 takes a value of 2°-40°.

The individual special fields refer to the threaded connection application fields where self-locking is required to be low or even self-locking is not required and/or self-positioning is required to be weak and/or axial bearing capacity is required to be high and/or transmission connection must be provided with anti-locking measures, etc.

For the bidirectional tapered threaded bolt and nut, the external thread is provided on the outer surface of the columnar body to form a bolt, wherein the columnar body has a screw. The truncated cone is spirally distributed on the outer surface of the screw. The truncated cone comprises an asymmetric bidirectional truncated cone. The columnar body can be solid or hollow, comprising workpieces and objects such as a cylinder and/or non-cylinder that need to process the thread on the outer surface, comprising the outer surface such as a cylindrical surface or a non-cylindrical surface such as a conical surface.

For the bidirectional tapered threaded bolt and nut, the asymmetric bidirectional truncated cone, that is, the external thread, is a thread formed in a spiral shape in which two truncated cones with the same lower bottom surfaces and the same upper top surfaces but different cone heights have symmetrical upper top surfaces which are mutually oppositely joined and lower bottom surfaces which are located at both ends of the bidirectional truncated cone and are mutually joined with the lower bottom surface of the adjacent bidirectional truncated cone and/or are mutually joined with the lower bottom surface of the adjacent bidirectional truncated cone when forming a dumbbell-like asymmetrical bidirectional tapered thread. The external threads comprise a first spiral conical surface of the truncated cone and a second spiral conical surface of the truncated cone and the outer spiral line. In the section passing through the thread axis, the whole single-section asymmetric bidirectional tapered external thread is a dumbbell-like special bidirectional tapered geometry with a small middle part and two large ends, and the conicity of the left side of the truncated cone is greater than the conicity of the right side of the truncated cone. The asymmetric bidirectional truncated cone comprises the conical surface of a bidirectional truncated cone. The included angle between two element lines of the conical surface of the left side, namely the first spiral conical surface of the truncated cone, is the first taper angle α1. The first spiral conical surface of the truncated cone forms the conicity of the left side and is distributed in the right direction. The included angle between two element lines of the conical surface of the right side, namely the second spiral conical surface of the truncated cone, is the second taper angle α2. The second spiral conical surface of the truncated cone forms the conicity of the right side and is distributed in the left direction. The first taper angle α1 and the second taper angle α2 correspond to the opposite conicity direction. The element line is the intersection of the conical surface and the plane passing through the conical axis. The shape formed by the first spiral conical surface of the truncated cone and the second spiral conical surface of the truncated cone of the bidirectional truncated cone is the same as the shape of the spiral outer side surface of the convolute formed by two bevel edges of the right-angled trapezoidal combination, the convolute rotates at a uniform speed in the circumferential direction, in which the right-angled side, which coincides with the central axis of the columnar body, of the right-angled trapezoidal combination with symmetrical and oppositely joined upper bottom lines of two right-angled trapezoids with the same lower bottom lines and the same upper bottom lines but different right-angled sides is taken as the center of rotation, and the right-angled trapezoidal combination simultaneously moves axially along the central axis of the columnar body at a uniform speed. The right-angled trapezoidal combination refers to a special geometry with symmetrical and oppositely joined upper bottom lines of two right-angled trapezoids with the same lower bottom lines and the same upper bottom lines but different right-angled sides and lower bottom lines which are located at both ends of the right-angled trapezoidal combination.

For the bidirectional tapered threaded bolt and nut, the internal thread is provided on the inner surface of the cylindrical body to form a nut, wherein the cylindrical body has a nut. The tapered holes are spirally distributed on the inner surface of the nut. The tapered hole comprises an asymmetric bidirectional tapered hole. The cylindrical body comprises workpieces and objects such as a cylinder and/or non-cylinder that need to process the internal thread on the inner surface. The inner surface comprises inner surface geometric shapes such as a cylindrical surface or a non-cylindrical surface such as a conical surface.

For the bidirectional tapered threaded bolt and nut, the asymmetric bidirectional tapered hole, that is, the internal thread, is a thread formed in a spiral shape in which two tapered holes with the same lower bottom surfaces and the same upper top surfaces but low cone heights have symmetrical upper top surfaces which are mutually oppositely joined and lower bottom surfaces which are located at both ends of the bidirectional tapered hole and are mutually joined with the lower bottom surface of the adjacent bidirectional tapered hole and/or are mutually joined with the lower bottom surface of the adjacent bidirectional tapered hole when forming a dumbbell-like asymmetrical bidirectional tapered thread. The internal threads comprise a first spiral conical surface of the tapered hole and a second spiral conical surface of the tapered hole and the inner spiral line. In the section passing through the thread axis, the whole single-section asymmetric bidirectional tapered internal thread is a dumbbell-like special bidirectional tapered geometry with a small middle part and two large ends, and the conicity of the left side of the tapered hole is greater than the conicity of the right side of the tapered hole. The bidirectional tapered hole comprises the conical surface of a bidirectional tapered hole. The included angle between two element lines of the conical surface of the left side, namely the first spiral conical surface of the tapered hole, is the first taper angle α1. The first spiral conical surface of the tapered hole forms the conicity of the left side and is distributed in the right direction. The included angle between two element lines of the conical surface of the right side, namely the second spiral conical surface of the tapered hole, is the second taper angle α2. The second spiral conical surface of the tapered hole forms the conicity of the right side and is distributed in the left direction. The first taper angle α1 and the second taper angle α2 correspond to the opposite conicity direction. The element line is the intersection of the conical surface and the plane passing through the conical axis. The shape formed by the first spiral conical surface of the tapered hole and the second spiral conical surface of the tapered hole of the bidirectional tapered hole is the same as the shape of the spiral outer side surface of the convolute formed by two bevel edges of the right-angled trapezoidal combination, the convolute rotates at a uniform speed in the circumferential direction, in which the right-angled side, which coincides with the central axis of the cylindrical body, of the right-angled trapezoidal combination with symmetrical and oppositely joined upper bottom lines of two right-angled trapezoids with the same lower bottom lines and the same upper bottom lines but different right-angled sides is taken as the center of rotation, and the right-angled trapezoidal combination simultaneously moves axially along the central axis of the cylindrical body at a uniform speed. The right-angled trapezoidal combination refers to a special geometry with symmetrical and oppositely joined upper bottom lines of two right-angled trapezoids with the same lower bottom lines and the same upper bottom lines but different right-angled sides and lower bottom lines which are located at both ends of the right-angled trapezoidal combination.

When the bidirectional tapered bolt-nut threaded connection structure works, the relationship with the workpiece comprises rigid connection and non-rigid connection. The rigid connection means that the nut supporting surface and the workpiece supporting surface are mutually supporting surfaces, comprising the structural form such as a single nut and double nuts. The non-rigid connection means that the opposite side end surfaces of the two nuts are mutually supporting surfaces and/or washers between the opposite side end faces of two nuts are indirectly mutually supporting surfaces. It is mainly used in non-rigid materials or non-rigid connection workpieces such as transmission parts, or application fields in which installation is achieved by double nuts to meet requirements. The workpiece refers to the connected object comprising the workpiece, and the washer refers to the spacer comprising the washer.

When the bidirectional tapered threaded bolt and nut adopt a bolt-double nut connection structure and the relationship with the fastened workpiece is rigid connection, the threaded working supporting surfaces are different. When the cylindrical body is located on the left side of the fastened workpiece, that is, when the left end surface of the fastened workpiece and the right end surface of the cylindrical body, that is, the left nut, are the locking supporting surface of the left nut and the fastened workpiece, the left nut and the cylindrical body, that is, the screw, that is, the spiral conical surface of the left side of the bidirectional tapered thread of the bolt, that is, the first spiral conical surface of the tapered hole and the first spiral conical surface of the truncated cone, are the tapered thread supporting surfaces, and the first spiral conical surface of the tapered hole and the first spiral conical surface of the truncated cone are the mutually supporting surfaces. When the cylindrical body is located on the right side of the fastened workpiece, that is, when the right end surface of the fastened workpiece and the left end surface of the cylindrical body, that is, the right nut, are the locking supporting surface of the right nut and the fastened workpiece, the right nut and the cylindrical body, that is, the screw, that is, the spiral conical surface of the right side of the bidirectional tapered thread of the bolt, that is, the second spiral conical surface of the tapered hole and the second spiral conical surface of the truncated cone, are the tapered thread supporting surfaces, and the second spiral conical surface of the tapered hole and the second spiral conical surface of the truncated cone are the mutually supporting surfaces.

When the bidirectional tapered threaded bolt and nut adopt a bolt-single nut connection structure and the relationship with the fastened workpiece is rigid connection, when the hexagon head of the bolt is on the left side, the cylindrical body, that is the nut, that is, the single nut, is located on the right side of the fastened workpiece. When the bolt-single nut connection structure works, the right end surface of the workpiece and the left end surface of the nut are the locking supporting surfaces of the nut and the fastened workpiece. The nut and the columnar body, that is, the screw, that is, the spiral conical surface of the right side of the bidirectional tapered thread of the bolt, that is, the second spiral conical surface of the tapered hole and the second spiral conical surface of the truncated cone, are the tapered thread supporting surfaces, and the second spiral conical surface of the tapered hole and the second spiral conical surface of the truncated cone are the mutually supporting surfaces; when the hexagon head of the bolt is on the right side, the columnar body, that is the nut, that is, the single nut, is located on the left side of the fastened workpiece. When the bolt-single nut connection structure works, the left end surface of the workpiece and the right end surface of the nut are the locking supporting surfaces of the nut and the fastened workpiece. The nut and the columnar body, that is, the screw, that is, the spiral conical surface of the left side of the bidirectional tapered thread of the bolt, that is, the first spiral conical surface of the tapered hole and the first spiral conical surface of the truncated cone, are the tapered thread supporting surfaces, and the first spiral conical surface of the tapered hole and the first spiral conical surface of the truncated cone are the mutually supporting surfaces

When the bidirectional tapered threaded bolt and nut adopt a bolt-double nut connection structure and the relationship with the fastened workpiece is non-rigid connection, the threaded working supporting surfaces, that is, the tapered threaded supporting surfaces, are different. The cylindrical body comprises a left nut and a right nut. The right end surface of the left nut and the left end surface of the right nut are in direct contact with each other oppositely and are mutually locking supporting surfaces. When the right end surface of the left nut is a locking support supporting surface, the left nut and the columnar body, that is, the screw, that is, the spiral conical surface of the left side of the bidirectional tapered thread of the bolt, that is, the first spiral conical surface of the tapered hole and the first spiral conical surface of the truncated cone, are the tapered thread supporting surfaces, and the first spiral conical surface of the tapered hole and the first spiral conical surface of the truncated cone are the mutually supporting surfaces. When the left end surface of the right nut is a locking support supporting surface, the right nut and the columnar body, that is, the screw, that is, the spiral conical surface of the right side of the bidirectional tapered thread of the bolt, that is, the second spiral conical surface of the tapered hole and the second spiral conical surface of the truncated cone, are the tapered thread supporting surfaces, and the second spiral conical surface of the tapered hole and the second spiral conical surface of the truncated cone are the mutually supporting surfaces.

When the bidirectional tapered threaded bolt and nut adopt a bolt-double nut connection structure and the relationship with the fastened workpiece is non-rigid connection, the threaded working supporting surfaces, that is, the tapered threaded supporting surfaces, are different. The cylindrical body comprises a left nut and a right nut, and there are spacers such as washers between the two cylindrical bodies, namely the left nut and the right nut. The right end surface of the left nut and the left end surface of the right nut are in indirect contact with each other oppositely through the washer, thereby indirectly acting as a mutually locking supporting surface. When the cylindrical body is on the left side of the washer, that is, when the left side surface of the washer and the right side end surface of the left nut are the locking supporting surface of the left nut, the left nut and the cylindrical body, that is, the screw, that is, the spiral conical surface of the left side of the bidirectional tapered thread of the bolt, that is, the first spiral conical surface of the tapered hole and the first spiral conical surface of the truncated cone, are the tapered thread supporting surfaces, and the first spiral conical surface of the tapered hole and the first spiral conical surface of the truncated cone are the mutually supporting surfaces. When the cylindrical body is on the right side of the washer, that is, when the right side surface of the washer and the left side end surface of the right nut are the locking supporting surface of the right nut, the right nut and the columnar body, that is, the screw, that is, the spiral conical surface of the right side of the bidirectional tapered thread of the bolt, that is, the second spiral conical surface of the tapered hole and the second spiral conical surface of the truncated cone, are the tapered thread supporting surfaces, and the second spiral conical surface of the tapered hole and the second spiral conical surface of the truncated cone are the mutually supporting surfaces.

When the bidirectional tapered threaded bolt and nut adopt a bolt-double nut connection structure and the relationship with the fastened workpiece is non-rigid connection, when the cylindrical body on the inner side, that is, the nut adjacent to the fastened workpiece, is effectively combined with the columnar body, that is, the screw, that is, the bolt, the internal thread and the external thread forming the tapered thread connection pair are effectively enveloped together. The cylindrical body on the outer side, that is, the nut that is not adjacent to the fastened workpiece, needs to remain intact and/or be disassembled, leaving only one nut according to the application working conditions (for example, the application fields that require lightweight devices or do not require double nuts to ensure the reliability of the connection technology). The removed nut is not used as a connecting nut, but is only used as an installation process nut. The internal thread of the installation process nut is not only made of bidirectional tapered threads, but also is the nut made of threads using unidirection tapered threads and other threads that can be screwed with tapered threads, comprising non-tapered threads such as triangular threads, trapezoidal thread, sawtooth threads, etc. On the premise of ensuring the reliability of the connection technology, the tapered thread connection pair is a closed-loop fastening technology system, that is, after the internal thread and the external thread of the tapered thread connection pair are effectively enveloped together, the tapered thread connection pair will become an independent technical system without relying on the technical compensation of the third party to ensure the technical validity of the connection technology system. Even if there is no support from other objects, the gap between the tapered thread connection pair and the fastened workpiece will not affect the effectiveness of the tapered thread connection pair. This will help greatly reduce the weight of the device, remove the ineffective load, and improve the technical requirements such as the effective load capacity, braking property, and energy conservation and emission reduction of the device. This is the advantage of thread technology that is unique no matter when the relationship between the tapered thread connection pair and the fastened workpiece of the bidirectional tapered bolt-nut threaded connection structure is non-rigid connection or rigid connection, and that other thread technologies do not have.

When the bidirectional tapered threaded bolt and nut are connected in transmission, the bidirectional tapered hole is screwed and connected to the bidirectional truncated cone, which bears in both directions. When the external thread and the internal thread form a thread pair, there must be a clearance between the bidirectional truncated cone and the bidirectional tapered hole. If there is oil and other media lubrication between the internal thread and the external thread, it will easily form a bearing oil film. The clearance is conducive to the formation of the bearing oil film. The bidirectional tapered thread bolt and nut are used in transmission connection, which is equivalent to a set of sliding bearing pairs formed by one pair and/or several pairs of sliding bearings, that is, each section of bidirectional tapered internal thread bidirectionally contains a corresponding section of bidirectional tapered external thread to form a pair of sliding bearings. The number of the formed sliding bearings is adjusted according to the application conditions, that is, the number of the containing and contained threaded section of the effective bidirectional engagement of the bidirectional tapered internal thread and the bidirectional tapered external thread, which is the effective bidirectional contact envelopment, is designed according to the application conditions. The bidirectional tapered hole contains the bidirectional truncated cone and is positioned in multiple directions such as in radial, axial, angular, and circumferential directions. Preferably, the bidirectional tapered hole contains the bidirectional truncated cone and is mainly positioned in radial and circumferential directions, and is supplementarily positioned in axial and angular directions so as to form the multi-directional positioning of the inner and outer cones until the conical surface of the bidirectional tapered hole and the conical surface of the bidirectional truncated cone are enveloped to achieve self-positioning or until the size realizes interference contact to realize self-locking. A special combining technology of the cone pair and the thread pair is formed to ensure the accuracy, efficiency and reliability of transmission connection of the tapered thread technology, especially the bidirectional tapered bolt-nut threaded connection structure.

When the bidirectional tapered threaded bolt and nut is connected in a fastened and sealed manner, its technical performance is realized by the screw connection of the bidirectional tapered hole and the bidirectional truncated cone, that is, the first spiral conical surface of the truncated cone and the first spiral conical surface of the tapered hole are sized until the interference is achieved, and/or the second spiral conical surface of the truncated cone and the second spiral conical surface of the tapered hole are sized until the interference is achieved. According to the application conditions, bearing is achieved in one direction and/or in two directions simultaneously. That is, the bidirectional truncated cone and the bidirectional tapered hole are guided by the spiral line, and the inner and outer diameters of the inner cone and the outer cone are centered until the first spiral conical surface of the tapered hole and the first spiral conical surface of the truncated cone are enveloped to bear in one direction and/or in two directions simultaneously to be sized for cooperation, or until the sizing interference contact is achieved, and/or the second spiral conical surface of the tapered hole and the second spiral conical surface of the truncated cone are enveloped to bear in one direction and/or in two directions simultaneously to be sized for cooperation, or until the sizing interference contact is achieved. The bidirectional tapered hole of the tapered internal thread contains the self-locking of the bidirectional truncated cone of the tapered external thread and is positioned in multiple directions such as in radial, axial, angular, and circumferential directions. Preferably, the bidirectional tapered hole contains the bidirectional truncated cone and is mainly positioned in radial and circumferential directions, and is supplementarily positioned in axial and angular directions so as to form the multi-directional positioning of the inner and outer cones until the conical surface of the bidirectional tapered hole and the conical surface of the bidirectional truncated cone are enveloped to achieve self-positioning or until the size realizes interference contact to realize self-locking. A special combining technology of the cone pair and the thread pair ensures the efficiency and reliability of the tapered thread technology, especially the bidirectional tapered threaded bolt and nut, so as to realize the technical performance of mechanical mechanism connection, locking, anti-loosening, bearing, fatigue and sealing.

Therefore, for the bidirectional tapered threaded bolt and nut, the technical performance, such as the transmission accuracy and efficiency, the bearing capacity, the self-locking force, the anti-loosening capacity, and the sealing property, is related to the first spiral conical surface of the truncated cone and the formed conicity of the left side, that is, the first taper angle α1, and the second spiral conical surface of the truncated cone and the formed conicity of the right side, that is, the second taper angle α2, the first spiral conical surface of the tapered hole and the formed conicity of the left side, that is, the first taper angle α1, and the second spiral conical surface of the tapered hole and the formed conicity of the right side, that is, the second taper angle α2. The material friction coefficient, processing quality and application conditions of the columnar body and the cylindrical body also have a certain influence on the cooperation of the cone.

In the bidirectional tapered threaded bolt and nut, when the right-angled trapezoid combination rotates at a uniform speed for a circle, the axial movement distance of the right-angled trapezoidal combination is at least twice the length of the sum of the right-angle sides of the two right-angled trapezoids with the same lower bottom lines and the same upper bottom lines but different right-angled sides. This structure ensures that the first spiral conical surface of the truncated cone and the second spiral conical surface of the truncated cone and the first spiral conical surface of the tapered hole and the second spiral conical surface of the tapered hole have sufficient length, thereby ensuring that when the conical surface of the bidirectional truncated cone is matched with the conical surface of the bidirectional tapered hole, it has sufficient effective contact area and strength as well as the efficiency required for spiral movement.

In the bidirectional tapered threaded bolt and nut, when the right-angled trapezoid combination rotates at a uniform speed for a circle, the axial movement distance of the right-angled trapezoidal combination is equal to the length of the sum of the right-angle sides of the two right-angled trapezoids with the same lower bottom lines and the same upper bottom lines but different right-angled sides. This structure ensures that the first spiral conical surface of the truncated cone and the second spiral conical surface of the truncated cone and the first spiral conical surface of the tapered hole and the second spiral conical surface of the tapered hole have sufficient length, thereby ensuring that when the conical surface of the bidirectional truncated cone is matched with the conical surface of the bidirectional tapered hole, it has sufficient effective contact area and strength as well as the efficiency required for spiral movement.

In the bidirectional tapered threaded bolt and nut, the first spiral conical surface of the truncated cone and the second spiral conical surface of the truncated cone are both continuous spiral surfaces or discontinuous spiral surfaces; the first spiral conical surface of the tapered hole and the second spiral conical surface of the tapered hole are both continuous spiral surfaces or discontinuous spiral surfaces.

In the bidirectional tapered threaded bolt and nut, when the cylindrical body connecting hole is screwed into the screwing end of the columnar body, there is a screwing direction requirement, that is, the cylindrical body connecting hole cannot be screwed in the opposite direction.

In the bidirectional tapered threaded bolt and nut, one end of the columnar body is provided with a head having a size larger than the outer diameter of the columnar body and/or one end and/or both ends of the columnar body are provided with a head smaller than the small diameter of the bidirectional tapered external thread of the columnar body screw. The connecting hole is a threaded hole provided on the nut. That is, the columnar body herein connected to the head is a bolt. The columnar body having no head and/or having the heads at both ends smaller than the small diameter of the bidirectional tapered external thread and/or having no thread in the middle but having bidirectional tapered external threads at both ends is a bolt. The connecting hole is provided in the nut.

Compared with the prior art, the advantages of the bidirectional tapered bolt-nut threaded connection structure are as follows: the design is reasonable, the structure is simple, the cone pair formed by centering the coaxial inner and outer diameters of the inner and outer cones bears or is sized in both directions until there is interference fit to realize the function of fastening and connection, it is convenient to operate, the locking force is large, the bearing value is large, the anti-loose performance is good, the transmission efficiency and the precision are high, the mechanical sealing effect is good, the stability is good, the loosening phenomenon can be prevented during connection, and there are self-locking and self-positioning functions.

### BRIEF DESCRIPTION OF THE DRAWINGS

FIG. 1 is a schematic diagram of a dumbbell-like (the conicity of the left side is greater than the conicity of the right side) asymmetric bidirectional tapered bolt-double nut threaded connection structure according to Embodiment 1 of the present invention.

FIG. 2 is a schematic diagram of a dumbbell-like (the conicity of the left side is greater than the conicity of the right side) asymmetric bidirectional tapered threaded structure of a nut of an external thread and a whole unit of an external thread according to Embodiment 1 of the present invention.

FIG. 3 is a schematic diagram of a dumbbell-like (the conicity of the left side is greater than the conicity of the right side) asymmetric bidirectional tapered threaded structure of a nut of an internal thread and a whole unit of an internal thread according to Embodiment 1 of the present invention.

FIG. 4 is a schematic diagram of a dumbbell-like (the conicity of the left side is greater than the conicity of the right side) asymmetric bidirectional tapered bolt-single nut threaded connection structure according to Embodiment 2 of the present invention.

FIG. 5 is a schematic diagram of a dumbbell-like (the conicity of the left side is greater than the conicity of the right side) asymmetric bidirectional tapered bolt-double nut threaded connection structure according to Embodiment 3 of the present invention.

FIG. 6 is a schematic diagram of a dumbbell-like (the conicity of the left side is greater than the conicity of the right side) asymmetric bidirectional tapered bolt-double nut (with a washer in the middle of the double nut) threaded connection structure according to Embodiment 4 of the present invention.

FIG. 7 is an illustration of “the thread of the existing thread technology being an inclined surface on a cylindrical or conical surface” involved in the background of the present invention.

FIG. 8 is an illustration of the “the inclined plane slider model of the principle of the existing thread technology—the inclined plane principle” involved in the background of the present invention.

FIG. 9 is an illustration of the “the thread lead angle of the existing thread technology” involved in the background of the present invention.

In the figures, tapered thread 1, cylindrical body 2, nut 21, nut 22, columnar body 3, screw 31, tapered hole 4, bidirectional tapered hole 41, conical surface of bidirectional tapered hole 42, first spiral conical surface of tapered hole 421, first taper angle α1, second spiral conical surface of tapered hole 422, second taper angle α2, internal spiral line 5, internal thread 6, truncated cone 7, bidirectional truncated cone 71, conical surface of bidirectional truncated cone 72, first spiral conical surface of truncated cone 721, first taper angle α1, second spiral conical surface of truncated cone 722, second taper angle α2, external spiral line 8, external thread 9, dumbbell-like 94, conicity of the left side 95, conicity of the right side 96, left distribution 97, right distribution 98, thread connection pair and/or thread pair 10, clearance 101, locking supporting surface 111, locking supporting surface 112, tapered thread supporting surface 122, tapered thread supporting surface 121, workpiece 130, nut locking direction 131, washer 132, conical axis 01, thread axis 02, slider on inclined surface A, inclined surface B, gravity G, component of gravity along inclined surface G1, friction F, thread lead angle φ, equivalent friction angle P, traditional external thread major diameter d, traditional external thread minor diameter d1, traditional external thread middle diameter d2.

### DESCRIPTION OF THE EMBODIMENTS

The present invention will be further described in detail below with reference to the drawings and specific embodiments.

### Embodiment 1

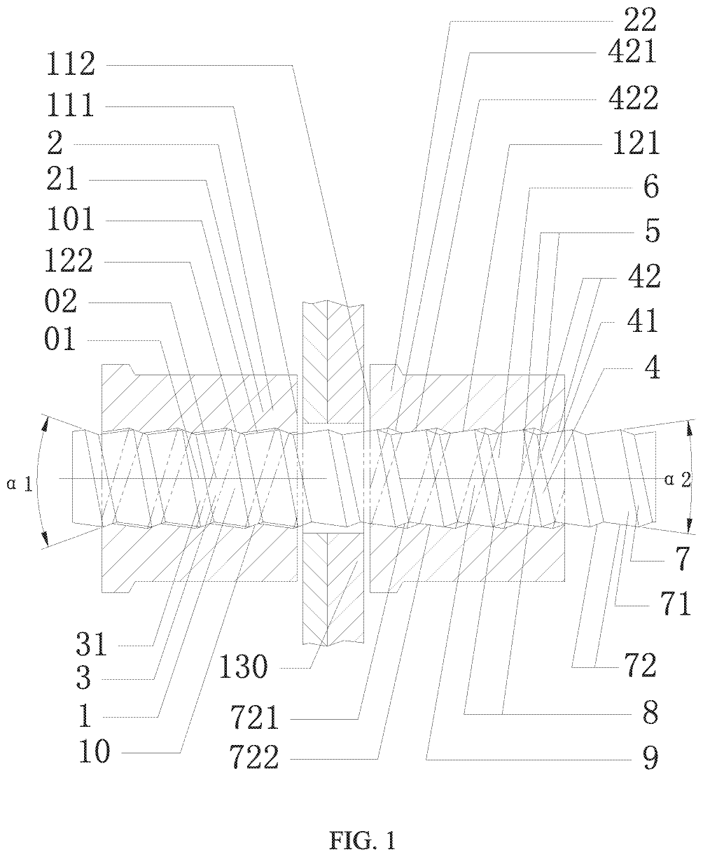

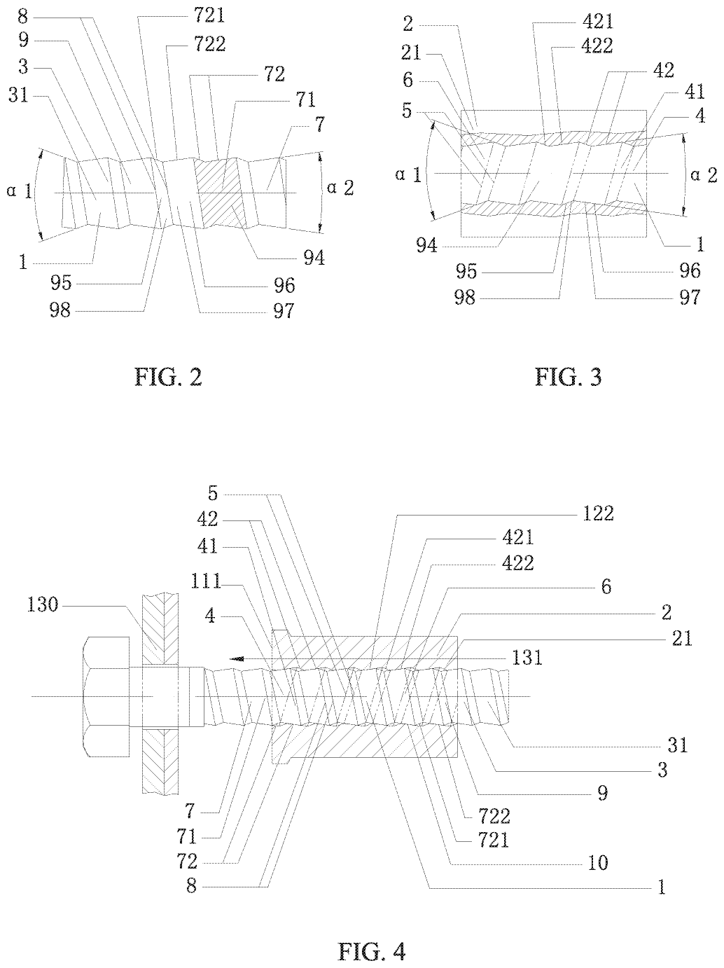

As shown in FIG. 1, FIG. 2, and FIG. 3, the present embodiment adopts a bolt-double nut connection structure, comprising a bidirectional truncated cone 71 spirally distributed on the outer surface of the columnar body 3 and a bidirectional tapered hole 41 spirally distributed on the inner surface of the cylindrical body 2, that is, comprising an external thread 9 and an internal thread 6 that are threaded with each other. The internal thread 6 distributes a spiral bidirectional tapered hole 41 and exists in the form of “non-solid space”, and the external thread 9 distributes a spiral bidirectional truncated cone 71 and exists in the form of a “material entity”. The internal thread 6 and the external thread 9 form the relationship of the containing part and the contained part: the internal thread 6 and the external thread 9 are bidirectional tapered geometries that are screwed and sleeved together until interference fit is achieved. That is, the bidirectional tapered hole 41 contains the bidirectional truncated cone 71 in sections. The bidirectional containment restricts the disordered degree of freedom between the tapered hole 4 and the truncated cone 7. The spiral movement allows the conical thread connection pair 10 of the bidirectional tapered threaded bolt and nut to obtain the necessary orderly degree of freedom, effectively combining the technical characteristics of the cone pair and the thread pair.

For the bidirectional tapered threaded bolt and nut in this embodiment, the conical cone 7 and/or the tapered hole 4 of the tapered thread connection pair 10 reach a certain conicity, that is, the cones forming the cone pair reach a certain taper angle. The tapered threaded connection pair 10 can have self-locking and self-positioning properties. The conicity comprises the conicity at the left side 95 and the conicity at the right side 96. The taper angle comprises the left taper angle and the right taper angle. In this embodiment, the asymmetric bidirectional tapered thread 1 has the conicity at the left side 95 greater than the conicity at the right side 96. The conicity at the left side 95 corresponds to the left taper angle, that is, the first taper angle α1, preferably, the first taper angle α1 is greater than 0° and less than 53 preferably, the first taper angle α1 takes a value of 2°-40°. In individual special fields, that is, connection application fields where self-locking is not required and/or self-positioning is required to be weak and/or axial bearing capacity is required to be high, preferably, the first taper angle α1 is greater than or equal to 530 and less than 180°, preferably, the first taper angle α1 takes a value of 53°-90°; the conicity at the right side 96 corresponds to the right taper angle, that is, the second taper angle α2, preferably, the second taper angle α2 is greater than 0° and less than 53°, preferably, the second taper angle α2 takes a value of 2°-40°.

The external thread 9 is provided on the outer surface of the columnar body 3, wherein the columnar body 3 has a screw 31. The truncated cone 7 is spirally distributed on the outer surface of the screw 31. The truncated cone 7 comprises an asymmetric bidirectional truncated cone 71. The asymmetric bidirectional truncated cone 71 is a dumbbell-like 94 special bidirectional tapered geometry. The columnar body 3 can be solid or hollow, comprising workpieces and objects such as a cylinder and/or a cone, a pipe that need to process the external thread on the outer surface.

The dumbbell-like 94 asymmetric bidirectional truncated cone 71 is formed in which two truncated cones with the same lower bottom surfaces and the same upper top surfaces but different cone heights have symmetrical upper top surfaces which are oppositely joined and lower bottom surfaces which are located at both ends of the bidirectional truncated cone 71 and are mutually joined with the lower bottom surface of the adjacent bidirectional truncated cone 71 and/or are mutually joined with the lower bottom surface of the adjacent bidirectional truncated cone 71 when forming an asymmetrical bidirectional tapered thread 1. The outer surface of the truncated cone 7 has a conical surface 72 of an asymmetric bidirectional truncated cone. The external threads 9 comprise a first spiral conical surface 721 of the truncated cone and a second spiral conical surface 722 of the truncated cone and the outer spiral line 8. In the section passing through the thread axis 02, the whole single-section asymmetric bidirectional tapered external thread 9 is a dumbbell-like 94 special bidirectional tapered geometry with a small middle part and two large ends, and the conicity of the left side of the truncated cone is greater than the conicity of the right side of the truncated cone. The asymmetric bidirectional truncated cone 71 comprises the conical surface 72 of a bidirectional truncated cone. The included angle between two element lines of the conical surface of the left side, namely the first spiral conical surface 721 of the truncated cone, is the first taper angle α1. The first spiral conical surface 721 of the truncated cone forms the conicity of the left side 95 and is distributed in the right direction 98. The included angle between two element lines of the conical surface of the right side, namely the second spiral conical surface 722 of the truncated cone, is the second taper angle α2. The second spiral conical surface 722 of the truncated cone forms the conicity of the right side 96 and is distributed in the left direction 97. The first taper angle α1 and the second taper angle α2 correspond to the opposite conicity direction. The element line is the intersection of the conical surface and the plane passing through the conical axis 01. The shape formed by the first spiral conical surface 721 of the truncated cone and the second spiral conical surface 722 of the truncated cone of the bidirectional truncated cone 71 is the same as the shape of the spiral outer side surface of the convolute formed by two bevel edges of the right-angled trapezoidal combination, the convolute rotates at a uniform speed in the circumferential direction, in which the right-angled side, which coincides with the central axis of the columnar body 3, of the right-angled trapezoidal combination with symmetrical and oppositely joined upper bottom lines of two right-angled trapezoids with the same lower bottom lines and the same upper bottom lines but different right-angled sides is taken as the center of rotation, and the right-angled trapezoidal combination simultaneously moves axially along the central axis of the columnar body 3 at a uniform speed. The right-angled trapezoidal combination refers to a special geometry with symmetrical and oppositely joined upper bottom lines of two right-angled trapezoids with the same lower bottom lines and the same upper bottom lines but different right-angled sides and lower bottom lines which are located at both ends of the right-angled trapezoidal combination.

The internal thread 6 is provided on the inner surface of the cylindrical body 2, wherein the cylindrical body 2 comprises a nut 21 and a nut 22. The inner surface of the nut 21 and the nut 22 has tapered holes 4 distributed spirally. The tapered holes 4 comprise an asymmetric bidirectional tapered hole 41. The asymmetric bidirectional tapered hole 41 is a dumbbell-like 94 special bidirectional cone geometry. The cylindrical body 2 comprises workpieces and objects such as a cylinder and/or non-cylinder that need to process the inner thread on the inner surface.

The dumbbell-like 94 asymmetric bidirectional tapered hole 41 is formed in which two tapered holes with the same lower bottom surfaces and the same upper top surfaces but low cone heights have symmetrical upper top surfaces which are oppositely joined and lower bottom surfaces which are located at both ends of the bidirectional tapered hole 41 and are mutually joined with the lower bottom surface of the adjacent bidirectional tapered hole 41 and/or are mutually joined with the lower bottom surface of the adjacent bidirectional tapered hole 41 when forming an asymmetrical bidirectional tapered thread 1. The tapered hole 4 comprises an asymmetric bidirectional tapered hole conical surface 42. The internal threads 6 comprise a first spiral conical surface 421 of the tapered hole and a second spiral conical surface 422 of the tapered hole and the inner spiral line 5. In the section passing through the thread axis 02, the whole single-section asymmetric bidirectional tapered internal thread 6 is a dumbbell-like 94 special bidirectional tapered geometry with a small middle part and two large ends, and the conicity of the left side of the tapered hole is greater than the conicity of the right side of the tapered hole. The bidirectional tapered hole 41 comprises the conical surface 42 of a bidirectional tapered hole. The included angle between two element lines of the conical surface of the left side, namely the first spiral conical surface 421 of the tapered hole, is the first taper angle α1. The first spiral conical surface 421 of the tapered hole forms the conicity of the left side 95 and is distributed in the right direction 98. The included angle between two element lines of the conical surface of the right side, namely the second spiral conical surface 422 of the tapered hole, is the second taper angle α2. The second spiral conical surface 422 of the tapered hole forms the conicity of the right side 96 and is distributed in the left direction 97. The first taper angle α1 and the second taper angle α2 correspond to the opposite conicity direction. The element line is the intersection of the conical surface and the plane passing through the conical axis 01. The shape formed by the first spiral conical surface 421 of the tapered hole and the second spiral conical surface 422 of the tapered hole of the bidirectional tapered hole 41 is the same as the shape of the spiral outer side surface of the convolute formed by two bevel edges of the right-angled trapezoidal combination, the convolute rotates at a uniform speed in the circumferential direction, in which the right-angled side, which coincides with the central axis of the cylindrical body 2, of the right-angled trapezoidal combination with symmetrical and oppositely joined upper bottom lines of two right-angled trapezoids with the same lower bottom lines and the same upper bottom lines but different right-angled sides is taken as the center of rotation, and the right-angled trapezoidal combination simultaneously moves axially along the central axis of the cylindrical body 2 at a uniform speed. The right-angled trapezoidal combination refers to a special geometry with symmetrical and oppositely joined upper bottom lines of two right-angled trapezoids with the same lower bottom lines and the same upper bottom lines but different right-angled sides and lower bottom lines which are located at both ends of the right-angled trapezoidal combination.

This embodiment adopts a bolt-double nut connection structure. The double nuts comprise a nut 21 and a nut 22. The nut 21 is located on the left side of the fastened workpiece 130, and the nut 22 is located on the right side of the fastened workpiece 130. When the bolt and the double nuts are working, the relationship with the fastened workpiece 130 is a rigid connection. The rigid connection means that the supporting surface of the nut end face and the supporting surface of the workpiece 130 are mutually supporting surfaces, comprising the locking supporting surface 111 and the locking supporting surface 112. The workpiece 130 refers to the connected object comprising the workpiece 130.

The threaded working supporting surfaces of this embodiment are different, comprising the tapered thread supporting surface 121 and the tapered thread supporting surface 122. When the cylindrical body 2 is located on the left side of the fastened workpiece 130, that is, when the left end surface of the fastened workpiece 130 and the right end surface of the cylindrical body 2, that is, the left nut 21, are the locking supporting surfaces 111 of the tapered thread supporting surface 121 and the tapered thread supporting surface 122, the left nut 21 and the cylindrical body 3, that is, the screw 31, that is, the spiral conical surface of the left side of the bidirectional tapered thread 1 of the bolt, are the threaded working supporting surfaces, that is, the first spiral conical surface 421 of the tapered hole and the first spiral conical surface 721 of the truncated cone are the tapered thread supporting surfaces 122, and the first spiral conical surface 421 of the tapered hole and the first spiral conical surface 721 of the truncated cone are the mutually supporting surfaces. When the cylindrical body 2 is located on the right side of the fastened workpiece 130, that is, when the right end surface of the fastened workpiece 130 and the left end surface of the cylindrical body 2, that is, the right nut 22, are the locking supporting surface 112 of the right nut 22 and the fastened workpiece 130, the right nut 22 and the cylindrical body 3, that is, the screw 31, that is, the spiral conical surface of the right side of the bidirectional tapered thread 1 of the bolt, are the threaded working supporting surfaces, that is, the second spiral conical surface 422 of the tapered hole and the second spiral conical surface 722 of the truncated cone are the tapered thread supporting surfaces 121, and the second spiral conical surface 422 of the tapered hole and the second spiral conical surface 7422 of the truncated cone are the mutually supporting surfaces.

When the bidirectional tapered threaded bolt and nut are connected in transmission, the bidirectional tapered hole 41 is screwed and connected to the bidirectional truncated cone 71, which bears in both directions. When the external thread 9 and the internal thread 6 form a thread pair 10, there must be a clearance 101 between the bidirectional truncated cone 71 and the bidirectional tapered hole 41. If there is oil and other media lubrication between the internal thread 6 and the external thread 9, it will easily form a bearing oil film. The clearance 101 is conducive to the formation of the bearing oil film. The tapered thread connection pair 10 is equivalent to a set of sliding bearing pairs formed by one pair or several pairs of sliding bearings, that is, each section of bidirectional tapered internal thread 6 bidirectionally contains a corresponding section of bidirectional tapered external thread 9 to form a pair of sliding bearings. The number of the formed sliding bearings is adjusted according to the application conditions, that is, the number of the containing and contained threaded section of the effective bidirectional engagement of the bidirectional tapered internal thread 6 and the bidirectional tapered external thread 9, which is the effective bidirectional contact envelopment, is designed according to the application conditions. The tapered hole 4 bidirectionally contains the truncated cone 7 and is positioned in multiple directions such as in radial, axial, angular, and circumferential directions. A special combining technology of the cone pair and the thread pair is formed to ensure the accuracy, efficiency and reliability of transmission connection of the tapered thread technology, especially the bidirectional tapered bolt-nut threaded connection structure.

When the bidirectional tapered threaded bolt and nut is connected in a fastened and sealed manner, its technical performance is realized by the screw connection of the bidirectional tapered hole 41 and the bidirectional truncated cone 71, that is, the first spiral conical surface 721 of the truncated cone and the first spiral conical surface 421 of the tapered hole are sized until the interference is achieved, and/or the second spiral conical surface 722 of the truncated cone and the second spiral conical surface 422 of the tapered hole are sized until the interference is achieved. According to the application conditions, bearing is achieved in one direction and/or in two directions simultaneously. That is, the bidirectional truncated cone 71 and the bidirectional tapered hole 41 are guided by the spiral line, and the inner and outer diameters of the inner cone and the outer cone are centered until the first spiral conical surface 421 of the tapered hole and the first spiral conical surface 721 of the truncated cone are enveloped, until the interference contact is achieved, and/or the second spiral conical surface 422 of the tapered hole and the second spiral conical surface 722 of the truncated cone are enveloped until the interference contact is achieved, so as to realize the technical performance of mechanical mechanism connection, locking, anti-loosening, bearing, fatigue and sealing.

Therefore, for the bidirectional tapered threaded bolt and nut in this embodiment, the technical performance, such as the transmission accuracy and transmission efficiency, the bearing capacity, the self-locking force, the anti-loosening capacity, the sealing property, and reusability is related to the first spiral conical surface 721 of the truncated cone and the formed conicity of the left side 95, that is, the first taper angle α1, and the second spiral conical surface 722 of the truncated cone and the formed conicity of the right side 96, that is, the second taper angle α2, the first spiral conical surface 421 of the tapered hole and the formed conicity of the left side 95, that is, the first taper angle α1, and the second spiral conical surface 422 of the tapered hole and the formed conicity of the right side 96, that is, the second taper angle α2. The material friction coefficient, processing quality and application conditions of the columnar body 3 and the cylindrical body 2 also have a certain influence on the cooperation of the cone.

In the bidirectional tapered threaded bolt and nut, when the right-angled trapezoid combination rotates at a uniform speed for a circle, the axial movement distance of the right-angled trapezoidal combination is at least twice the length of the sum of the right-angle sides of the two right-angled trapezoids with the same lower bottom lines and the same upper bottom lines but different right-angled sides. This structure ensures that the first spiral conical surface 721 of the truncated cone and the second spiral conical surface 722 of the truncated cone and the first spiral conical surface 421 of the tapered hole and the second spiral conical surface 422 of the tapered hole have sufficient length, thereby ensuring that when the conical surface 72 of the bidirectional truncated cone is matched with the conical surface 42 of the bidirectional tapered hole, it has sufficient effective contact area and strength as well as the efficiency required for spiral movement.

In the bidirectional tapered threaded bolt and nut, when the right-angled trapezoid combination rotates at a uniform speed for a circle, the axial movement distance of the right-angled trapezoidal combination is equal to the length of the sum of the right-angle sides of the two right-angled trapezoids with the same lower bottom lines and the same upper bottom lines but different right-angled sides. This structure ensures that the first spiral conical surface 721 of the truncated cone and the second spiral conical surface 722 of the truncated cone and the first spiral conical surface 421 of the tapered hole and the second spiral conical surface 422 of the tapered hole have sufficient length, thereby ensuring that when the conical surface 72 of the bidirectional truncated cone is matched with the conical surface 42 of the bidirectional tapered hole, it has sufficient effective contact area and strength as well as the efficiency required for spiral movement.

In the bidirectional tapered threaded bolt and nut, the first spiral conical surface 721 of the truncated cone and the second spiral conical surface 722 of the truncated cone are both continuous spiral surfaces or discontinuous spiral surfaces; the first spiral conical surface 421 of the tapered hole and the second spiral conical surface 422 of the tapered hole are both continuous spiral surfaces or discontinuous spiral surfaces.

In the bidirectional tapered threaded bolt and nut, when the cylindrical body 2 connecting hole is screwed into the screwing end of the columnar body 3, there is a screwing direction requirement, that is, the cylindrical body 2 connecting hole cannot be screwed in the opposite direction.

In the bidirectional tapered threaded bolt and nut, one end of the columnar body 3 is provided with a head having a size larger than the outer diameter of the columnar body 3 and/or one end and/or both ends of the columnar body 3 are provided with a head smaller than the small diameter of the external thread 9 of the tapered thread of the columnar body 3 screw 31. The connecting hole is a threaded hole provided on the nut 21. That is, the columnar body 3 herein connected to the head is a bolt. The columnar body having no head and/or having the heads at both ends smaller than the small diameter of the bidirectional tapered external thread 9 and/or having no thread in the middle but having bidirectional tapered external threads 9 at both ends is a bolt. The connecting hole is provided in the nut 21.

Compared with the prior art, the advantages of the tapered threaded connection pair 10 of the bidirectional tapered bolt-nut threaded connection structure are as follows: the design is reasonable, the structure is simple, the cone pair formed by the inner and outer cones is sized until there is interference fit to realize the function of fastening and connection, it is convenient to operate, the locking force is large, the bearing value is large, the anti-loose performance is good, the transmission efficiency and the precision are high, the mechanical sealing effect is good, the stability is good, the loosening phenomenon can be prevented during connection, and there are self-locking and self-positioning functions.

### Embodiment 2

As shown in FIG. 4, the structure, principle and implementation steps of this embodiment are similar to those of Embodiment 1. The difference is that this embodiment adopts a bolt-single nut connection structure and the bolt has a hexagonal head larger than the screw 31. When the hexagon head of the bolt is on the left side, the cylindrical body 2, that is the nut 21, that is, the single nut, is located on the right side of the fastened workpiece 130. When the bolt-single nut connection structure of this embodiment works, the relationship with the fastened workpiece 130 is also rigid connection. The rigid connection means that the end face of the nut 21 and the opposite end surfaces of the end face of the workpiece 130 are mutually supporting surfaces. The supporting surface is the locking supporting surface 111. The workpiece 130 refers to a connected object comprising the workpiece 130.

The threaded working supporting surface of this embodiment is the tapered threaded supporting surface 122, that is, the cylindrical body 2, that is, the nut 21, that is, the single nut, is located on the right side of the fastened workpiece 130. When the bolt-single nut connection structure works, the right end surface of the workpiece 130 and the left end surface of the nut 21 are the locking supporting surfaces 111 of the nut 21 and the fastened workpiece 130. The right spiral conical surface of the nut 21 and the cylindrical body 3, that is, the screw 31, that is, the bidirectional tapered thread 1 of the bolt, is the threaded working supporting surface, that is, the second spiral conical surface 422 of the tapered hole and the second spiral conical surface 722 of the truncated cone are the tapered thread supporting surfaces 122, and the second spiral conical surface 422 of the tapered hole and the second spiral conical surfaces 722 of the truncated cone are mutually supporting surfaces.

In this embodiment, when the hexagon head of the bolt is located on the right side, its structure, principle and implementation steps are similar to those of this embodiment.

### Embodiment 3

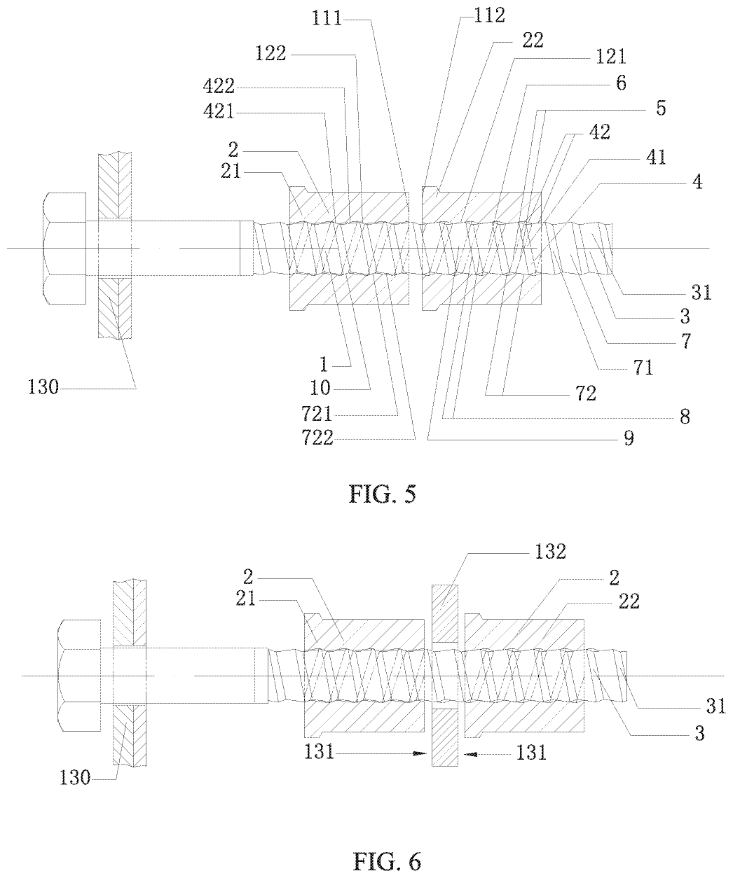

As shown in FIG. 5, the structure, principle and implementation steps of this embodiment are similar to those of Embodiment 1. The difference is that the positional relationship between the double nuts and the fastened workpiece 130 is different. The double nuts comprise a nut 21 and a nut 22. The bolt has a hexagonal head larger than the screw 31. When the hexagonal head of the bolt is on the left side, the nut 21 and the nut 22 are both on the right side of the fastened workpiece 130. When the bolt-double nut connection structure works, the relationship between the nut 21, the nut 22 and the fastened workpiece 130 is non-rigid connection. The non-rigid connection means that the opposite side surfaces of the two nuts, namely the nut 21 and the nut 22, are mutually supporting surfaces. The supporting surface comprises a locking supporting surface 111 and a locking supporting surface 112, which is mainly used in non-rigid materials or non-rigid connection workpieces 130 such as transmission parts, or application fields in which installation is achieved by double nuts to meet requirements. The workpiece 130 refers to the connected object comprising the workpiece 130.

The threaded working supporting surface of this embodiment is different, comprising a tapered thread supporting surface 121 and a tapered thread supporting surface 122. The cylindrical body 2 comprises a left nut 21 and a right nut 22. The right end surface of the left nut 21 (that is, the locking supporting surface 111) and the left end surface of the right nut 22 (that is, the locking supporting surface 112) are in direct contact with each other oppositely and are mutually locking supporting surfaces. When the right end surface of the left nut 21 is a locking support supporting surface 111, the left nut 21 and the columnar body 3, that is, the screw 31, that is, the spiral conical surface of the left side of the bidirectional tapered thread 1 of the bolt, are threaded working supporting surfaces, that is, the first spiral conical surface 421 of the tapered hole and the first spiral conical surface 721 of the truncated cone are the tapered thread supporting surfaces 122, and the first spiral conical surface 421 of the tapered hole and the first spiral conical surface 721 of the truncated cone are the mutually supporting surfaces. When the left end surface of the right nut 22 is a locking support supporting surface 112, the right nut 22 and the columnar body 3, that is, the screw 31, that is, the spiral conical surface of the right side of the bidirectional tapered thread 1 of the bolt, are threaded working supporting surfaces, that is, the second spiral conical surface 422 of the tapered hole and the second spiral conical surface 722 of the truncated cone are the tapered thread supporting surfaces 121, and the second spiral conical surface 422 of the tapered hole and the second spiral conical surface 722 of the truncated cone are the mutually supporting surfaces.

In this embodiment, when the cylindrical body 2 on the inner side, that is, the nut 21 adjacent to the fastened workpiece 130, is effectively combined with the columnar body 3, that is, the screw 31, that is, the bolt, the internal thread 6 and the external thread 9 forming the tapered thread connection pair 10 are effectively enveloped together. The cylindrical body 2 on the outer side, that is, the nut 22 that is not adjacent to the fastened workpiece 130, needs to remain intact and/or be disassembled, leaving only one nut according to the application working conditions (for example, the application fields that require lightweight devices or do not require double nuts to ensure the reliability of the connection technology). The removed nut 22 is not used as a connecting nut, but is only used as an installation process nut. The internal thread of the installation process nut is not only made of bidirectional tapered threads, but also is the nut 22 made of threads using unidirection tapered threads and other threads that can be screwed with tapered threads 1, comprising non-tapered threads such as triangular threads, trapezoidal thread, sawtooth threads, etc. On the premise of ensuring the reliability of the connection technology, the tapered thread connection pair 10 is a closed-loop fastening technology system, that is, after the internal thread 6 and the external thread 9 of the tapered thread connection pair 10 are effectively enveloped together, the tapered thread connection pair 10 will become an independent technical system without relying on the technical compensation of the third party to ensure the technical validity of the connection technology system. Even if there is no support from other objects, the gap between the tapered thread connection pair 10 and the fastened workpiece 130 will not affect the effectiveness of the tapered thread connection pair 10. This will help greatly reduce the weight of the device, remove the ineffective load, and improve the technical requirements such as the effective load capacity, braking property, and energy conservation and emission reduction of the device. This is the advantage of thread technology that is unique no matter when the relationship between the tapered thread connection pair 10 and the fastened workpiece 130 of the bidirectional tapered bolt-nut threaded connection structure is non-rigid connection or rigid connection, and that other thread technologies do not have.

In this embodiment, when the hexagon head of the bolt is located on the right side, the nut 21 and the nut 22 are both located on the left side of the fastened workpiece 130, and the structure, principle and implementation steps are similar to those of this embodiment.

### Embodiment 4

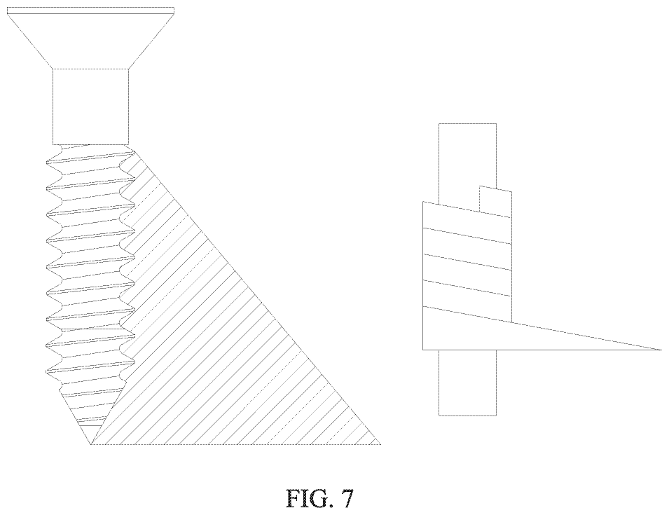

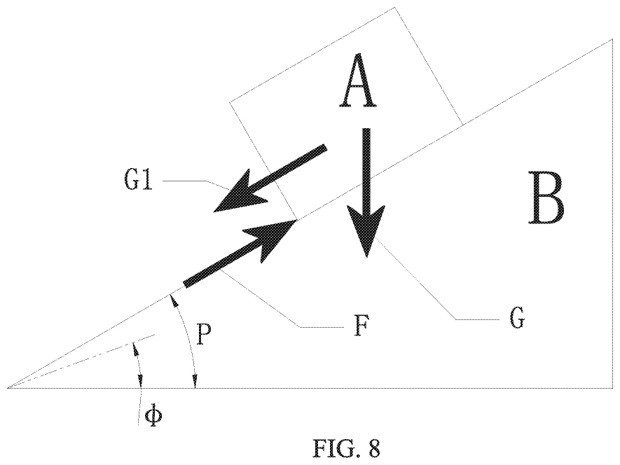

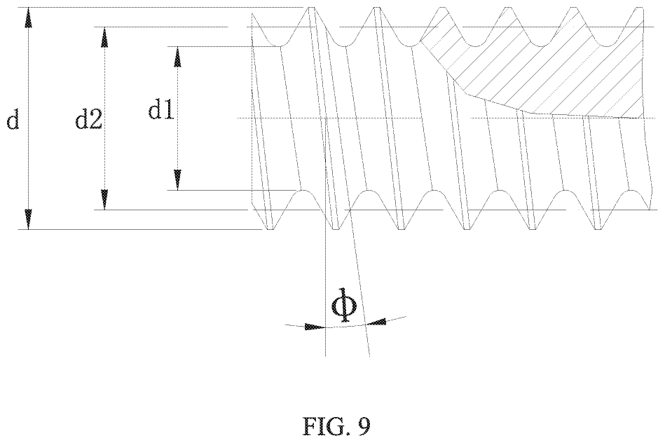

As shown in FIG. 6, the structure, principle, and implementation steps of this embodiment are similar to those of Embodiment 1 and 3. The difference is that based on the third embodiment, this embodiment adds spacers such as washers 132 between the nut 21 and the nut 22. That is, the right end surface of the left nut 21 and the left end surface of the right nut 22 are in indirect contact with each other oppositely through the washer 132, thereby indirectly acting as a mutually locking supporting surface. That is, the mutual relationship between the right end surface of the left nut 21 and the left side end surface of the right nut 22 has changed from the direct mutually locking supporting surface to the indirect mutually locking supporting surface.

The specific embodiments described herein are merely examples to illustrate the spirit of the present invention. Those skilled in the art to which the present invention pertains can make various modifications or additions to the described specific embodiments or use similar alternatives, but they will not deviate from the spirit of the present invention or exceed the scope defined by the appended claims.

Although the present invention more widely uses tapered thread 1, cylindrical body 2, nut 21, nut 22, columnar body 3, screw 31, tapered hole 4, bidirectional tapered hole 41, conical surface of bidirectional tapered hole 42, first spiral conical surface of tapered hole 421, first taper angle α1, second spiral conical surface of tapered hole 422, second taper angle α2, internal spiral line 5, internal thread 6, truncated cone 7, bidirectional truncated cone 71, conical surface of bidirectional truncated cone 72, first spiral conical surface of truncated cone 721, first taper angle α1, second spiral conical surface of truncated cone 722, second taper angle α2, external spiral line 8, external thread 9, dumbbell-like 94, conicity of the left side 95, conicity of the right side 96, left distribution 97, right distribution 98, thread connection pair and/or thread pair 10, clearance 101, self-locking force, self-locking, self-positioning, intensity of pressure, conical axis 01, thread axis 02, mirror image, bushing, shaft, single-tapered body, double-tapered body, cone, inner cone, tapered hole, outer cone, cone, cone pair, spiral structure, spiral movement, thread, whole unit thread, axial force, axial force angle, anti-axial force, anti-axial force angle, centripetal force, anti-centripetal central force, oppositely collinear, internal stress, bidirectional force, unidirection force, sliding bearing, sliding bearing pair, locking supporting surface 111, locking supporting surface 112, tapered thread supporting surface 122, tapered thread supporting surface 121, non-solid space, material entity, workpiece 130, nut locking direction 131, non-rigid connection, non-rigid material, transmission part, washer 132, etc., the possibility of using other terms is not excluded. These terms are used only for more convenient description and explanation of the essence of the present invention, and interpreting them as any additional limitation is contrary to the spirit of the present invention.

I claim:

1. A dumbbell-like bidirectional tapered bolt-nut threaded connection structure with a large-conicity left side and a small-conicity right side, which is a dumbbell-like (the conicity of the left side is greater than the conicity of the right side) asymmetric bidirectional tapered bolt-nut threaded connection structure, comprising an external thread (9) and an internal thread (6) in screw-thread fit with the external thread (9); wherein the whole unit thread of the dumbbell-like (the conicity of the left side is greater than the conicity of the right side) asymmetric bidirectional tapered thread (1) is a spiral dumbbell-like (94) asymmetric bidirectional tapered body with a small middle part and two large ends; the conicity of the left side (95) is greater than the conicity of the right side (96), and the tapered body comprises a bidirectional tapered hole (41) and/or a bidirectional truncated cone (71); the thread of the internal thread (6) is a cylindrical body (2) with a spiral bidirectional tapered hole (41) on the inner surface and exists in the form of non-solid space; the thread of the external thread (9) is a columnar body (3) with a spiral bidirectional truncated cone (71) on the outer surface and exists in the form of a material entity; the left taper surface of the asymmetric bidirectional tapered body forms a first taper angle (α1) corresponding to the conicity of the left side (95), the right taper surface forms a second taper angle (α2) corresponding to the conicity of the right side (96); the conicity of the left side (95) and the conicity of the right side (96) have opposite directions and different sizes; the internal thread (6) and the external thread (9) enclose the tapered body through the tapered hole till the inner and outer taper surfaces bear mutually; the technical performance mainly depends on the taper surfaces and the conicity size of the threads matching with each other, preferably, the first taper angle (α1) is greater than 0° and less than 53°, the second taper angle (α2) is greater than 0° and less than 53°, and for individual special fields, preferably, the first taper angle (α1) is greater than or equal to 530 and less than 180°.

2. The connection structure of claim 1, wherein the dumbbell-like (94) bidirectional tapered internal thread (6) comprises a left conical surface of a conical surface (42) of the bidirectional tapered hole, which is a first spiral conical surface (421) of the tapered hole, a right conical surface, which is a second spiral conical surface (422) of the tapered hole, and an inner spiral line (5); the shape formed by the first spiral conical surface (421) of the tapered hole and the second spiral conical surface (422) of the tapered hole, that is, the bidirectional spiral conical surface, is the same as the shape of the spiral outer side surface of the convolute formed by two bevel edges of the right-angled trapezoidal combination, the convolute rotates at a uniform speed in the circumferential direction, in which the right-angled side, which coincides with the central axis of the cylindrical body (2), of the right-angled trapezoidal combination with symmetrical and oppositely joined upper bottom lines of two right-angled trapezoids with the same lower bottom lines and the same upper bottom lines but different right-angled sides is taken as the center of rotation, and the right-angled trapezoidal combination simultaneously moves axially along the central axis of the cylindrical body (2) at a uniform speed; the dumbbell-like (94) bidirectional tapered external thread (9) comprises a left conical surface of a conical surface (72) of the bidirectional truncated cone, which is a first spiral conical surface (721) of the truncated cone, a right conical surface, which is a second spiral conical surface (722) of the truncated cone, and an outer spiral line (8), the shape formed by the first spiral conical surface (721) of the truncated cone and the second spiral conical surface (722) of the truncated cone, that is, the bidirectional spiral conical surface, is the same as the shape of the spiral outer side surface of the convolute formed by two bevel edges of the right-angled trapezoidal combination, the convolute rotates at a uniform speed in the circumferential direction, in which the right-angled side, which coincides with the central axis of the columnar body (3), of the right-angled trapezoidal combination with symmetrical and oppositely joined upper bottom lines of two right-angled trapezoids with the same lower bottom lines and the same upper bottom lines but different right-angled sides is taken as the center of rotation, and the right-angled trapezoidal combination simultaneously moves axially along the central axis of the columnar body (3) at a uniform speed.

3. The connection structure of claim 2, wherein when the right-angled trapezoid combination rotates at a uniform speed for a circle, the axial movement distance of the right-angled trapezoidal combination is at least twice the length of the sum of the two right-angled trapezoidal right-angle sides of the right-angled trapezoidal combination.

4. The connection structure of claim 2, wherein when the right-angled trapezoidal combination rotates at a constant speed for a circle, the axial movement distance of the right-angled trapezoidal combination is equal to the length of the sum of the two right-angled trapezoidal right-angle sides of the right-angled trapezoidal combination.

5. The connection structure of claim 1, wherein the left conical surface and the right conical surface of the bidirectional tapered body, which are the first spiral conical surface (421) of the tapered hole and the second spiral conical surface (422) of the tapered hole, and the inner spiral line (5) are all continuous spiral surfaces or discontinuous spiral surfaces and/or the first spiral conical surface (721) of the truncated cone and the second spiral conical surface (722) of the truncated cone and the outer spiral (8) are all continuous spiral surfaces or discontinuous spiral surfaces.

6. The connection structure of claim 1, wherein the internal thread (6) is a dumbbell-like (94) asymmetrical bidirectional tapered internal thread (6) formed in a spiral shape in which two tapered holes (4) with the same lower bottom surfaces and the same upper top surfaces but different cone heights have symmetrical upper top surfaces which are mutually oppositely joined and lower bottom surfaces which are located at both ends of the bidirectional tapered hole (41) and are mutually joined with the lower bottom surface of the adjacent bidirectional tapered hole (41) and/or are mutually joined with the lower bottom surface of the adjacent bidirectional tapered hole (41) when forming a dumbbell-like (94) asymmetrical bidirectional tapered thread (1), and the external thread (9) is a dumbbell-like (94) asymmetrical bidirectional tapered external thread (9) formed in a spiral shape in which two truncated cones (7) with the same lower bottom surfaces and the same upper top surfaces but different cone heights have symmetrical upper top surfaces which are mutually oppositely joined and lower bottom surfaces which are located at both ends of the bidirectional truncated cone (7) and are mutually joined with the lower bottom surface of the adjacent bidirectional truncated cone (7) and/or are mutually joined with the lower bottom surface of the adjacent bidirectional truncated cone (7) when forming a dumbbell-like (94) asymmetrical bidirectional tapered thread (1).

7. The connection structure of claim 1, wherein the internal thread (6) and the external thread (9) form a thread pair (10), the first spiral conical surface (421) of the tapered hole and the second spiral conical surface (422) of the tapered hole, and the first spiral conical surface (721) of the truncated cone and the second spiral conical surface (722) of the truncated cone, which are matched with each other, take the contact surface as the supporting surface, the inner and outer diameters of the inner cone and outer cone are centered when being guided by the spiral line until the conical surface (42) of the bidirectional tapered hole and the conical surface (72) of the bidirectional truncated cone are enveloped so that the spiral conical surface bears in one direction and/or the spiral conical surface bears in two directions simultaneously and/or until the size realizes self-positioning contact and/or the size realizes interference contact to be self-locked.

8. The connection structure of claim 1, wherein the connection structure of a bolt and double nuts is adopted, in which the double nuts are respectively located on the left and right sides of the fastened workpiece, and/or the connection structure of a bolt and a single nut is adopted, in which a single nut (21) is located on the right or left side of the fastened workpiece, and/or the connection structure of a bolt and double nuts is adopted, in which the double nuts are located on one side of the fastened workpiece; and when a nut has been effectively combined with the bolt, the internal thread (6) and the external thread (9) forming the tapered threaded connection pair (10) are effectively enveloped together, the other nut can be removed and/or retained, the removed nut is used as an installation process nut, the internal thread comprises a traditional thread, such as a bidirectional tapered thread (1), a unidirection tapered thread and a triangular thread, a trapezoidal thread, a sawtooth thread, a rectangular thread, a circular arc thread, etc., which complies with the technical spirit of the present invention due to being in screw-thread fit with the bidirectional tapered external thread (9).

9. The connection structure of claim 1, wherein when the connecting hole of the cylindrical body (2) is screwed into the screw-in end of the columnar body (3), there is a screw-in direction requirement, that is, the connecting hole of the cylindrical body (2) cannot be screwed in the opposite direction, the connecting hole is a threaded hole provided on the nut (21) and the nut (22), the connecting hole is provided in the nut (21) and the nut (22), and the nut refers to the object comprising a nut with a threaded structure on the inner surface of the cylindrical body (2).

10. The connection structure of claim 1, wherein the internal thread (6) and/or the external thread (9) comprises a single thread body which is an incomplete tapered geometry, that is, the single thread body is an incomplete unit thread.
